(19) United States
(12) Patent Application Publication
(10) Pub. No.: US 2022/0111677 A1
(43) Pub. Date: Apr. 14, 2022

(54) METHOD AND DEVICE FOR MAKING DESIGNS ON A SUBSTRATE

(71) Applicant: SandCrayon Inc., Old Lyme, CT (US)

(72) Inventors: Hunter Ward, Old Lyme, CT (US); Jeremy Blubaugh, Henrico, VA (US)

(21) Appl. No.: 17/479,076

(22) Filed: Sep. 20, 2021

Related U.S. Application Data
(63) Continuation-in-part of application No. 17/070,418, filed on Oct. 14, 2020, now abandoned.

(51) Int. Cl. B44D 3/22; B05B 11/00

(52) U.S. Cl. CPC B44D 3/22; B05B 11/02; B05B 11/0081

(57) ABSTRACT

A device and method for making design on a substrate includes providing a device having a body defining an interior volume fluidly connected to an inlet/discharge opening, a fluid modification element arranged in the interior volume, the fluid modification element having a coloring substance and/or a liquid thickener. If the fluid modification element has the coloring substance, the coloring substance is configured to color liquid that comes in contact with the coloring substance. If the fluid modification element has the liquid thickener, the liquid thickener is configured to thicken liquid that comes in contact with the liquid thickener. The device is configured to draw liquid from exterior of the device into the interior volume through the inlet/discharge opening. The device is configured to discharge liquid from the interior volume through the inlet/discharge opening onto a substrate arranged at an area exterior of the device.

### CROSS-REFERENCE TO RELATED APPLICATION

This application is a continuation-in-part of U.S. patent application Ser. No. 17/070,418, filed Oct. 14, 2020, which is hereby incorporated by reference in its entirety.

### TECHNICAL FIELD

The present disclosure relates to methods and devices for making designs on a substrate and, more particularly, for making colored and/or thickened liquid designs on a substrate.

### BACKGROUND

Being at the beach is fun and there are many things to do there to keep yourself busy. However, it is difficult to draw or make colored art on the sand with markers, crayons, or other typical traditional drawing implements one may typically use when creating art or designs. For example, the sand may move, gum up the tool being used to draw on the sand, and is generally a terrible medium for drawing on. This is unfortunate as children and adults alike would benefit from a useful tool that would allow them to create temporary colored art easily and repeatedly on the sand.

### SUMMARY

According to the present disclosure, a device for making designs on a substrate includes a body defining an interior volume fluidly connected to an inlet/discharge opening, a fluid modification element arranged in the interior volume, the fluid modification element having a coloring substance and/or a liquid thickener. If the fluid modification element has the coloring substance, the coloring substance is configured to color liquid that comes in contact with the coloring substance. If the fluid modification element has the liquid thickener, the liquid thickener is configured to thicken liquid that comes in contact with the liquid thickener. The device is configured to draw liquid from the exterior of the device into the interior volume through the inlet/discharge opening. The device is also configured to discharge liquid from the interior volume through the inlet/discharge opening onto a substrate arranged at an area exterior of the device.

A method according to the present disclosure for making a design on a substrate includes providing a device, the device including a body defining an interior volume fluidly connected to an inlet/discharge opening, a fluid modification element arranged in the interior volume, the fluid modification element having a coloring substance and/or a liquid thickener. If the fluid modification element has the coloring substance, the coloring substance is configured to color liquid that comes in contact with the coloring substance. If the fluid modification element has the liquid thickener, the liquid thickener is configured to thicken liquid that comes in contact with the liquid thickener. The device is configured to draw liquid from the exterior of the device into the interior volume through the inlet/discharge opening. The device is also configured to discharge liquid from the interior volume to an area exterior of the device through the inlet/discharge opening. The method further includes drawing liquid into the interior volume of the device from a water body, and then discharging the liquid from the interior volume of the device onto a substrate arranged at an area exterior of the device, thereby making a design.

### BRIEF DESCRIPTION OF THE DRAWINGS

FIG. 1 is a front perspective view of a device for making designs on a substrate in accordance with the present disclosure;

FIG. 2 is an enlarged view of a fluid modification element of the device of FIG. 1;

FIG. 3A is an illustration of a user using the device of FIG. 1 in accordance with the present disclosure;

FIG. 3B is an illustration of the user of FIG. 3A further using the device of FIG. 1;

FIG. 3C is an illustration of the user of FIG. 3A further using the device of FIG. 1;

FIG. 4 is a front perspective view of the device of FIG. 1 with the cap removed;

FIG. 5 is a front view of a device for making designs on a substrate in accordance with the present disclosure;

FIG. 6 is a front view of a device for making designs on a substrate in accordance with the present disclosure;

FIG. 7 is a front view of a device for making designs on a substrate in accordance with the present disclosure; and

FIG. 8 is an illustration of a user using the device of FIG. 1 in accordance with the present disclosure.

### DETAILED DESCRIPTION

Before the various embodiments are described in further detail, it is to be understood that the invention is not limited to the particular embodiments described. It is also to be understood that the terminology used is for the purpose of describing particular embodiments only, and is not intended to limit the scope of the claims of the present application.

In the drawings, like reference numerals refer to like features of the device for making designs on a substrate of the present disclosure. Accordingly, although certain descriptions may refer only to certain figures and reference numerals, it should be understood that such descriptions might be equally applicable to like reference numerals in other figures. Additionally, although various features have been shown in different figures for simplicity, it should be readily apparent to one of skill in the art that various features may be combined without departing from the scope of the present disclosure.

Referring to FIG. 1, an illustration of an exemplary device 10 for making designs is shown in accordance with embodiments of the present disclosure. The device 10 includes a body 12 extending in a generally longitudinal direction 14. The body 12 has an open end 16, a closed end 18 closed by a cap 19, and an intermediate portion 20 between the open end 16 and closed end 18. The body 12 defines an inlet/discharge opening 22 at the open end 16. The body 12 defines an interior volume 24 that is fluidly connected to the inlet/discharge opening 22. The cap 19 is detachably attached to the body 12 such that the cap 19 may be repeatedly detached and attached to the body 12 to form an air and liquid tight seal with the body 12 (or in some embodiments, only a liquid tight seal).

A fluid modification element 26 is movably arranged within the interior volume 24. The fluid modification element 26 has a size and/or a shape that prevents the fluid modification element 26 from moving through the inlet/discharge opening 22 to an area exterior of the body 12.

The device 10 is configured to withdraw fluid that is exterior of the device 10 into the interior volume 24 through the inlet/discharge opening 22 and to discharge fluid from the interior volume 24 to the exterior of the device through the inlet/discharge opening 22. In the embodiment shown in FIG. 1, the device 10 is configured to reduce a volume of the interior volume 24 from a maximum volume defined when the body 12 is in a normal position, such that some or all of the fluid contained in the interior volume 24 is discharged through the inlet/discharge opening 22 when fluid is contained within the interior volume 24 and the volume is reduced. The body 12 reduces the volume of the interior volume 24 when a force is applied to the intermediate portion 20, for example, by a user squeezing the intermediate portion 20. The body 12 is configured to elastically return to the normal position after the force causing the reduction in volume is removed, thereby increasing the volume of the interior volume 24 back to the maximum volume and causing a suction force at the inlet/discharge opening 22. The suction force causes fluid and/or gas exterior to the body 12 to be drawn into the interior volume 24 through the inlet/discharge opening 22.

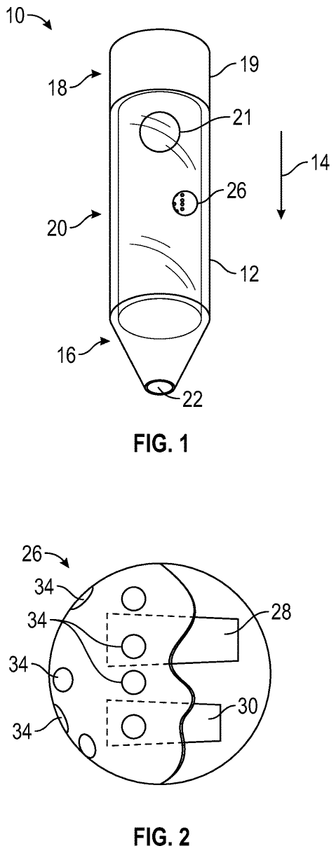

Referring to FIG. 2, the fluid modification element 26 of FIG. 1 is shown in more detail. The fluid modification element 26 includes a coloring substance 28 and/or a liquid thickener 30 within an internal volume 32. The internal volume 32, coloring substance 28 and liquid thickener 30 are fluidly connected to the exterior of the fluid modification element 26 through one or more pores 34 (or any other fluid channel types). The coloring substance 28 and the liquid thickener 30 may be dissolvable and soluble in water or in another liquid. The coloring substance 28 and/or liquid thickener 30 may be configured to slowly release or dissolve upon contact with water or another liquid. In some embodiments, there may be two fluid modification elements 26, one containing a coloring substance 28 and another containing a liquid thickener 30.

The coloring substance 28 is configured to color liquid that comes in contact with the coloring substance 28. The coloring substance 28 may be one or more of any known coloring substances, such as, for example and without limitation, coloring dyes, coloring pigments, or the like. For example and without limitation, a coloring substance may include one or more natural colorants and dyes derived from plants and plant tissue, such as phenolics, carotenoids, betacyanins, anthocyanins, and the like. Synthetic colorants and dyes include but are not limited to Allura Red AC, Brilliant Blue FCF, Erythrosine, Fast Green FCF, Sunset Yellow FCF, and the like.

The liquid thickener 30 is configured to thicken liquid that comes in contact with the liquid thickener 30, thereby increasing the viscosity of the liquid. The liquid thickener 30 may be one or more of any known synthetic or natural liquid thickeners, such as, for example and without limitation, corn starch, gelatin, pectin, silica, algin, gum arabic, banana flakes, or the like. In some embodiments, the liquid thickener 30 may include a chemical surfactant, such as, for example and without limitation, sodium lauryl sulfoacetate (SLSa). Additionally, a chemical reaction between baking soda and citric acid may serve to help mix the coloring substance 28 and liquid thickener 30 while also increasing the viscosity of the liquid.

In some embodiments, the coloring substance 28 and liquid thickener 30 are a single integrated element. In other words, a single integrated element or composition functions to color the liquid and make the liquid have greater thickness. In some embodiments, the coloring substance 28 and/or the liquid thickener 30 are a plurality of coloring substances 28 and/or liquid thickeners 30, e.g. a plurality of dissolvable beads, flake, or powders.

The coloring substance 28 and/or the liquid thickener 30 may be environmentally friendly such that the substance is safe for dispersion in the environment or water body, or is at least legally allowed for dispersion into the environment by federal and/or state governments; for example, a substance (or class of substance) classified by the U.S. Environmental Protection Agency as safe for beaches, safe for normal waste, or the like.

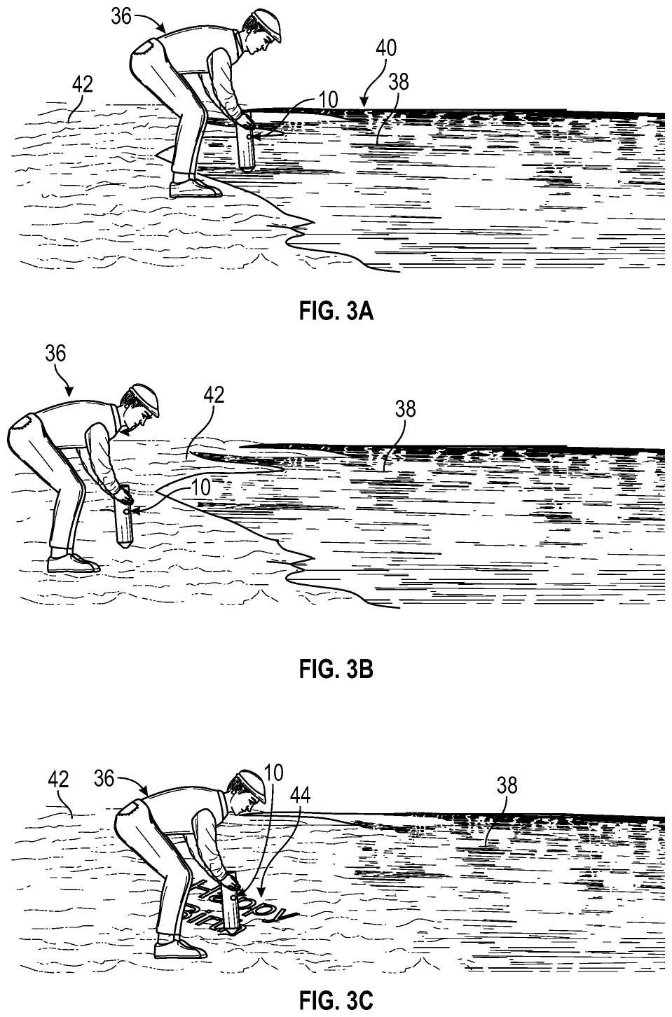

FIGS. 3A-3C illustrate a user using the device 10 of FIG. 1 in accordance with the present disclosure. In operation, a user 36 inserts the device 10 into a water body 38 such that the inlet/discharge opening 22 is submerged beneath the surface 40 of the water body 38, as shown in FIG. 3A. The water body 38 may be an ocean, lake, pond, river, or any other similar body of water. While the inlet/discharge opening 22 is submerged, the user 36 causes the device 10 to withdraw fluid from the water body 38 to enter the interior volume 24 through the inlet/discharge opening 22, e.g. by reducing the volume of the interior volume 24 and then allowing the body to return to the normal position thereby increasing the volume of the interior volume 24 to generate a suction force at the inlet/discharge opening 22.

Then, the user 36 removes the device 10 from the water body 38. At this time, the device 10 contains the liquid in the interior volume 24 that was withdrawn from the water body 38. The liquid is in contact with the coloring substance 28 and the liquid thickener 30, which causes the liquid to become colored (i.e. appear as a different color to a user) and have greater thickness. The user 36 may optionally shake the device 10 in order to stir the liquid in the interior volume 24, thereby promoting faster coloring by the coloring substance 28 and/or faster liquid thickening by the liquid thickener 30 than what would occur during simple diffusion without shaking.

As shown in FIG. 3B, the user 36 may then position the device 10 at or near a substrate 42 such that the device 10 is pointing the inlet/discharge opening 22 towards the substrate 42. In FIG. 3B, the substrate 42 is beach sand.

Then, the user 36 causes the device 10 to discharge the liquid contained in the interior volume 24 through the inlet/discharge opening 22 to make a design 44 on the substrate 42, as shown in FIG. 3C. The user 36 may selectively move the device 10 and/or selectively cause the device to discharge the colored and thickened liquid to make virtually any kind of design 44, such as, any kind of letter, character, symbol, drawing, or the like. As discussed above, the coloring substance 28 and liquid thickener 30 may advantageously be made of non-toxic and/or environmentally friendly substances such that the discharged colored, thickened liquid is safe for discharge into the environment.

The user 36 may continue the discharging of the colored and/or thickened liquid until the interior volume 24 is void of liquid (or the device 10 is incapable of discharging any more liquid). The user 36 may repeatedly withdraw liquid from the water body 38 and discharge the liquid as desired. After the coloring substance 28 and/or the liquid thickener 30 are depleted, the user may resume the process with a new device 10 having sufficient coloring substance 28 and/or liquid thickener, i.e. in some embodiments the device 10 is non-reloadable and disposable.

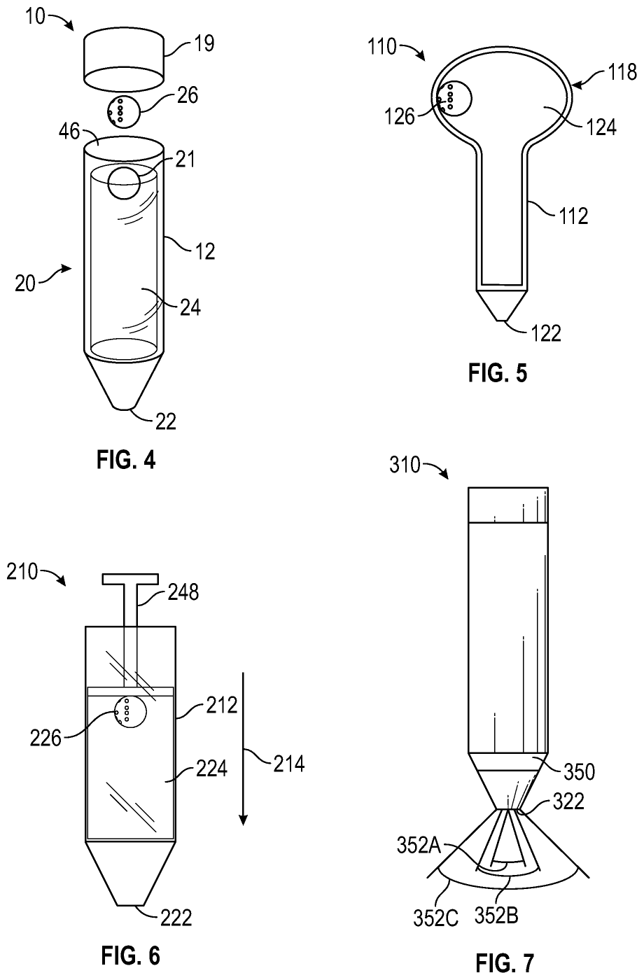

Alternatively, in other embodiments, the device 10 may be reloadable. For instance, referring to FIG. 4, an illustration of the device 10 is shown with the cap 19 removed from the body 12 revealing an access opening 46 that allows access to the interior volume 24. Instead of disposing of the device 10, the user 36 may reload the interior volume 24 with a new fluid modification element 26 by detaching the cap 19 from the body 12, removing the depleted fluid modification element 26 through the access opening 46, inserting a new fluid modification element 26, and attaching the cap 19 back to the body 12 in order to resume making designs in the manner discussed above. Rather than removing the depleted fluid modification element 26 and inserting a new fluid modification element 26, the user 26 may instead reload the depleted fluid modification element 26 with additional coloring substance(s) 28 and/or liquid thickener(s) 30 and re-insert the reloaded fluid modification element 26 into the interior volume. In some embodiments, the fluid modification element 26 may be securely fixed to the cap 19 and not movable within the interior volume 24.

Instead of a removable cap 19, or in addition thereto, the body 12 may have a removable portion 21 arranged on the body 12 at the intermediate portion 20. The removable portion is detachably attached to the body 12 similar to the cap 19, and can be removed from the body 12 to allow the fluid modification element 26 to be removed and/or inserted through an opening closed by the removable portion 21, if desired.

The water body 38 may be any body of water (or other liquid). For example, the water body 38 may be the ocean, a river, lake, pond, stream, pool, or the like. The substrate 42 may be any substrate. For example, the substrate 42 may be gravel, snow, ice, soil, mud, grass, clay, asphalt, concrete, mulch, or the like. In some embodiments, the substrate 42 may be a sidewalk or a road.

The cap 19 may be detachably attached to the body 12 through any known connection mechanisms or methods. For example and without limitation, the cap 19 may connect to the body 12 through a threaded engagement that allows the cap 19 to be screwed on to the body 12, the cap 19 may engage the body 12 in an interference fit manner, the cap 19 may engage the body 12 with clasps, magnets, or a hinge mechanism, or the like. However, other connection mechanisms and methods are within the scope of the present disclosure. The cap 19 and/or the body 12 may have one or more seals (e.g. o-rings) in order to form a liquid tight seal when the cap 19 is attached to the body 12. The removable portion 21 may attach to the body 12 with a similar connection mechanism or method as the cap 19, or may attach through other known connection mechanisms and methods.

The device 10 of FIG. 1 is in the shape of crayon. However, the device 10 may be virtually any kind of shape. For example and without limitation, the device 10 may be in the shape of a pen, pencil, paint brush, marker, chalk piece, or the like. Further, the device 10 and/or interior volume 24 may be formed in a variety of sizes. For example and without limitation, the size of the device 10 or interior volume 24 may be 15 fluid oz., 16 fluid oz., 17 fluid oz., or 24 fluid oz.

While the device 10 of the present disclosure has been shown and described as being configured to withdraw and discharge fluid by applying a force to the intermediate portion 20, other fluid withdrawal and discharge mechanisms are within the scope of the present disclosure. For example, referring to FIGS. 5 and 6, illustrations of exemplary devices 110, 210 for making designs on a substrate are shown in accordance with the present disclosure. The device 110 of FIG. 5 is similar to the device 10 of FIG. 1, except that the closed end 118 of the device 110 includes a flexible bulb and, instead of applying a force to an intermediate portion to draw liquid into and discharge liquid from the interior volume 124, a user draws liquid into and discharges liquid from the interior volume 124 through the inlet/discharge opening 122 by applying a squeezing force to the flexible bulb. The fluid modification element 126 may be fixed to an internal wall of the body 112 of the device 110 by any know fastening structures or techniques, such that the fluid modification element 126 is not free to move within the interior volume 124.

The device 210 of FIG. 6 includes a piston 248 moveable within the interior volume 224 to draw liquid into and discharge liquid from the interior volume 224 through the inlet/discharge opening 222. The fluid modification element 226 may be fixed to the piston 248. A user may move the piston 248 in the longitudinal direction 214 similar to the operation of a syringe device. The body 212 of the device 210 of FIG. 6 may be made with rigid or non-flexible materials since the body 212 does not need to be squeezed in order for the liquid to be withdrawn or discharged from the interior volume 224.

Referring to FIG. 7, an illustration of a device 310 for making designs on a substrate is shown in accordance with the present disclosure. The device 310 includes a nozzle adjuster 350 for adjusting a size and/or shape of the inlet/discharge opening 322. Based on the position of the nozzle adjuster 350, a user can set a discharge spray angle 352A, 352B, 352C to a desired angle when liquid is discharged from the device 310. Thus, the user can choose to set the device 310 to discharge at a concentrated discharge spray angle (e.g. spray angle 352A) or to discharge at a wide discharge spray angle (e.g. spray angle 352C).

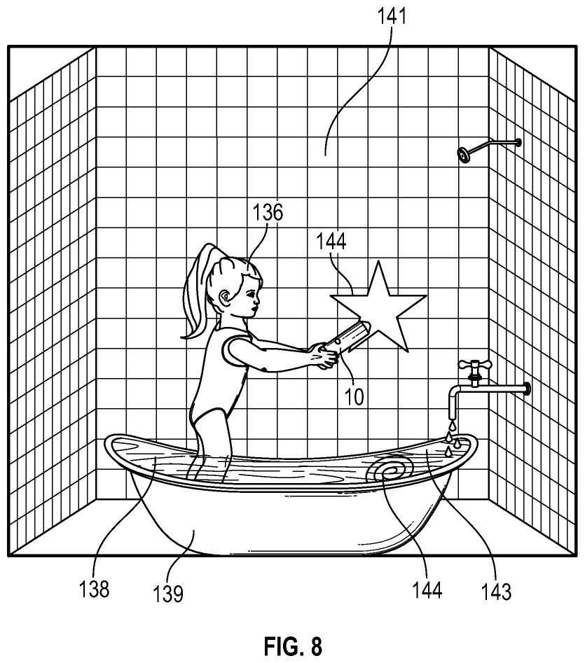

Referring to FIG. 8, an illustration of a user 136 using the device 10 of FIG. 1 in an indoor bathroom environment is shown in accordance with embodiments of the present disclosure. The operation of the device 10 is similar to the operation described above in connection with FIGS. 3A-3C and is not repeated here. The user (e.g. a child) 136 causes the device 10 to discharge liquid contained in the interior volume 24 through the inlet/discharge opening 22 to make designs 144 on available substrates, which in this example, is a bathroom wall 141 and/or a bathtub wall 143. While the design 144 is shown as being made on a portion of the bathtub wall 143 submerged beneath the surface of the water 138, it is within the scope of the present application for the design 144 to be made on a portion of the bathtub wall 143 above the surface of the water 138. The user 136 may selectively move the device 10 and/or selectively cause the device to discharge the colored and thickened liquid to make virtually any kind of design 144, such as, any kind of letter, character, symbol, drawing, or the like. As discussed above, the coloring substance 28 and liquid thickener 30 may advantageously be made of non-toxic and/or environmentally friendly substances such that the discharged colored, thickened liquid is safe for discharge into the environment.

The devices and methods according to the present disclosure advantageously address the need for an easy and safe way to make designs using readily available liquid, especially when at a beach, whether the beach is at an ocean, lake, pond, river, or any other body of water (natural or artificial). The devices and methods according to the present disclosure allow users to mix the available water with a coloring substance and/or liquid thickener, and then then subsequently squirt the modified liquid onto the beach sand to draw or create designs or art.

While the present disclosure has been illustrated and described with respect to particular embodiments thereof, it should be appreciated by those of ordinary skill in the art that various modification to this disclosure may be made without departing from the spirit and scope of the present disclosure.

What is claimed is:

1. A method for making a design on a substrate, the method comprising:
providing a device, the device comprising:
a body defining an interior volume, the interior volume being fluidly connected to an inlet/discharge opening formed through the body;
a fluid modification element arranged in the interior volume, the fluid modification element having a coloring substance and/or a liquid thickener;
wherein, if the fluid modification element has the coloring substance, the coloring substance is configured to color liquid that comes in contact with the coloring substance;
wherein, if the fluid modification element has the liquid thickener, the liquid thickener is configured to thicken liquid that comes in contact with the liquid thickener;
wherein the device is configured to draw liquid from exterior of the device into the interior volume through the inlet/discharge opening; and
wherein the device is configured to discharge liquid from the interior volume to an area exterior of the device through the inlet/discharge opening;
drawing liquid into the interior volume of the device from a water body; and
discharging the liquid from the interior volume of the device onto a substrate arranged at an area exterior of the device thereby making a design.

2. The method according to claim 1, wherein the fluid modification element has both the coloring substance and the liquid thickener.

3. The method according to claim 1, further comprising:
shaking the device;
wherein the shaking occurs after the drawing the liquid into the interior volume of the device and before the discharging the liquid from the interior volume of the device to an area exterior of the device.

4. The method according to claim 3,
wherein, if the fluid modification element has the coloring substance, the shaking results in the liquid appearing as a different color; and
wherein, if the fluid modification element has the liquid thickener, the shaking results in the liquid having a greater thickness.

5. The method according to claim 3,
wherein, if the fluid modification element has the coloring substance, the shaking results in the liquid appearing as a different color faster than what would occur during simple diffusion without shaking; and
wherein, if the fluid modification element has the liquid thickener, the shaking results in the liquid having a greater thickness faster than what would occur during simple diffusion without shaking.

6. The method according to claim 1, further comprising:
removing the fluid modification element from the interior volume;
wherein the fluid modification element has a size and/or a shape that prevents the fluid modification element from moving through the inlet/discharge opening.

7. The method according to claim 6, further comprising:
inserting a second fluid modification element into the interior volume, the second fluid modification element having a second coloring substance and/or a second liquid thickener.

8. The method according to claim 6, further comprising:
removing an end cap of the device from the body;
wherein the removing the end cap of the device from the body occurs before the removing the fluid modification element from the interior volume.

9. The method according to claim 1, wherein the substrate is sand or snow.

10. The method according to claim 1, wherein the water body is a pond, lake, river or ocean.

11. The method according to claim 1, wherein the water body is bath water contained in a bathtub.

12. The method according to claim 1, wherein the substrate is a bathroom wall.

13. The method according to claim 1, wherein the substrate is a bathtub wall.

14. The method according to claim 1, wherein the coloring substance and/or the liquid thickener are arranged within an internal volume of the fluid modification element.

15. The method according to claim 1, wherein the discharging the liquid is accomplished by squeezing an exterior portion of the body.

16. The method according to claim 1, wherein the device further comprises a piston arranged within the body, and wherein the discharging is accomplished by moving the piston.

17. The method according to claim 1, wherein the fluid modification element has the liquid thickener, and where in the liquid thickener includes a chemical surfactant.

18. The method according to claim 1, wherein the substrate is a sidewalk or a road.

19. The method according to claim 1, wherein the fluid modification element includes citric acid and baking soda.

20. The method according to claim 1, wherein the fluid modification element has the coloring substance, and wherein the coloring substance comprises one or more coloring dyes.
